(19) United States
(12) Patent Application Publication
(10) Pub. No.: US 2009/0303730 A1
(43) Pub. Date: Dec. 10, 2009

(54) Light Fixture Having A Glare-Eliminating Optical System

(75) Inventor: Stein Martin Holmberg, Oslo (NO)

Correspondence Address: WEITZMAN LAW OFFICES, LLC, 425 EAGLE ROCK AVENUE, SUITE 102, ROSELAND, NJ, 07068, US

(73) Assignee: LUXO ASA, Oslo (NO)

(21) Appl. No.: 12/205,337

(22) Filed: Sep. 5, 2008

Related U.S. Application Data
(60) Provisional application No. 61/059,894, filed on Jun. 9, 2008.

(51) Int. Cl. F21V 5/02

(52) U.S. Cl. 362/311.01

(57) ABSTRACT

An undercabinet light fixture, comprising a housing for supporting a light source. A glare-eliminating optical system is mounted on the housing and through which light illuminated by the light source passes. The glare-eliminating optical system includes a textured surface and a non-textured surface. The textured surface includes an array of longitudinally extending prismatic elements for redirecting light illuminated from the light source. The non-textured surface is located below the light source and permits light illuminated from the light source to pass therethrough without being substantially redirected.

### CROSS REFERENCE TO RELATED PATENT APPLICATION

This application claims the benefit of U.S. Provisional Patent Application No. 61/059,894, filed Jun. 9, 2008, the entire disclosure of which is incorporated by reference herein.

### FIELD

This application relates generally to light fixtures, and more particularly, to an improved undercabinet light fixture having a glare-eliminating optical system.

### BACKGROUND

Light fixtures are used in a wide variety of applications to provide effective illumination. One example is the use of an undercabinet light fixture mounted beneath a cabinet, shelf or other surface to illuminate a workspace or desktop. These light fixtures often utilize fluorescent lamps as a light source due to their low cost, high surface brightness, high efficiency and long life characteristics.

A significant characteristic of any light fixture design is whether the light fixture produces undesirable glare (direct or reflected) that adversely affects a person's ability to work or sit comfortably in proximity to the light fixture. Many light fixtures incorporate plastic or glass diffusers or refractive lenses to combat undesirable glare. Such conventional diffusers or lenses cover or otherwise surround the light source and typically include prisms and other shapes along their surface to scatter, redirect or refract light rays at various angles.

In applications where the light fixture is at or slightly above eye level (e.g., undercabinet mounting), these conventional diffusers or lenses have proven ineffective in eliminating undesirable direct glare. There is, therefore, a need to eliminate direct glare in applications where the light fixture is located at or slightly above eye level.

### SUMMARY

In accordance with one aspect of this disclosure, an undercabinet light fixture having a glare-eliminating optical system is disclosed. The undercabinet light fixture comprises a housing for supporting a light source. The glare-eliminating optical system is mounted on the housing and through which light illuminated by the light source passes. The glare-eliminating optical system includes a textured surface and a non-textured surface. The textured surface includes an array of longitudinally extending prismatic elements for redirecting light illuminated from the light source. The non-textured surface is located below the light source and permits light illuminated from the light source to pass therethrough without being substantially redirected.

These and other advantages of the present disclosure will be apparent to those of ordinary skill in the art by reference to the following detailed description and the accompanying drawings.

### BRIEF DESCRIPTION OF THE DRAWINGS

FIG. 1 is a side elevation view of an undercabinet light fixture mounted on an exemplary workstation;

FIG. 2 is a perspective view of an undercabinet light fixture incorporating a glare-eliminating optical system;

FIG. 3 is a top plan view of the undercabinet light fixture of FIG. 2;

FIG. 4 illustrates the undercabinet light fixture of FIG. 3 with the glare-eliminating optical system removed from the light fixture;

FIG. 5 is a top plan view of the undercabinet light fixture of FIG. 2;

FIG. 6 is a cross-sectional, side elevation view of the undercabinet light fixture of FIG. 5 taken across line 6-6; and

FIG. 7 is a side elevation view of the glare-eliminating optical system.

### DETAILED DESCRIPTION

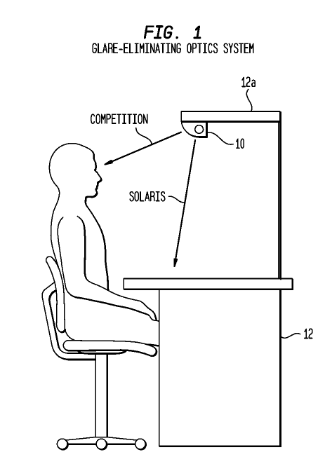

FIG. 1 illustrates an undercabinet light fixture 10 mounted on a shelf or overhanging structure 12a of an exemplary workstation 12. A user is shown sitting at the workstation 12 with the light fixture 10 mounted at or slightly above eye level. As discussed above, existing undercabinet light fixtures tend to generate undesirable direct glare in which light from the light source (e.g., fluorescent lamp) is scattered, redirected or refracted by a conventional diffuser or lens cover in the direction of the arrow labeled “Competition.”

As will be discussed below, the undercabinet light fixture 10 that is the subject of the present application utilizes a glare-eliminating optical system 30 to avoid or minimize instances of direct glare, as is illustrated by the arrow labeled “Solaris.” While the glare-eliminating optical system 30 is described herein as being utilized with an undercabinet light fixture 10 having a fluorescent lamp as a light source 22, it is understood that the glare-eliminating optical system 30 may be utilized with various light sources, including, but not limited to, fluorescent lamps, halogen lamps, incandescent lamps and light emitting diodes (LEDs).

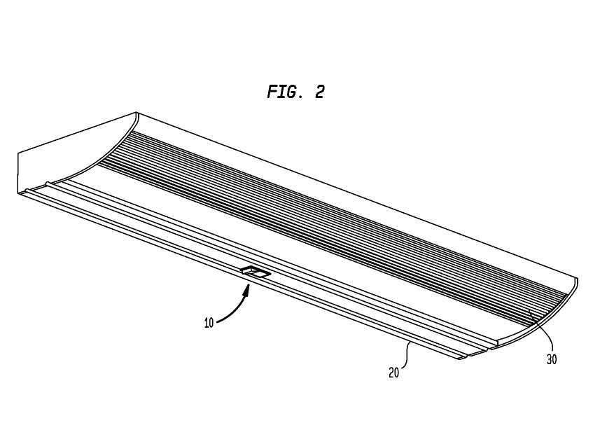

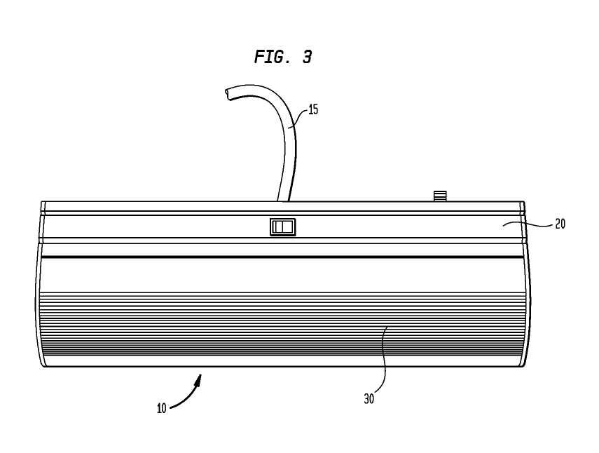

FIGS. 2 and 3 illustrate a preferred undercabinet light fixture 10 incorporating the glare-eliminating optical system 30, which will be described further below. The light fixture 10 includes a housing 20 for holding at least one light source 22. The housing 20 is preferably made from aluminum or any other suitable material. A power cord 15 for providing electrical power to the light source is shown extending from the housing 20.

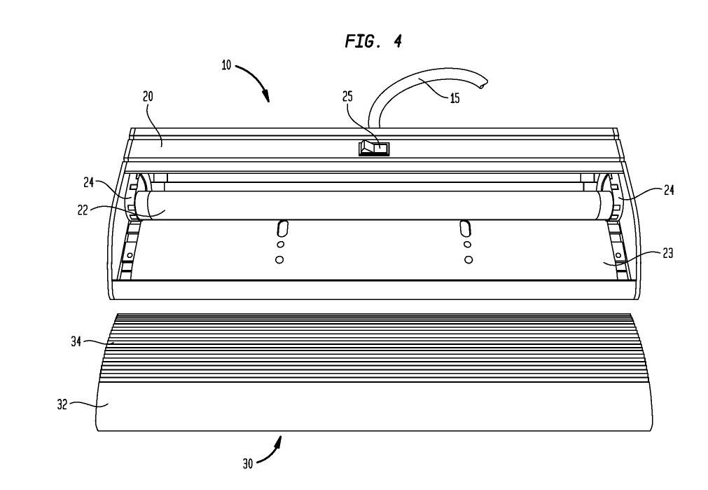

FIG. 4 illustrates the light fixture 10 with the glare-eliminating optical system 30 removed. The light source 22 is preferably a tubular fluorescent lamp, such as a T5 or T8 fluorescent lamp, which is mounted in and powered by a pair of conventional slotted power sockets or lamp holders 24. The housing 20 also preferably includes conventional ballast for electrically connecting the light source 22 to a power source via power cord 15, which may be activated by on/off switch 25. A reflector 23 for providing increased light output is preferably mounted in the housing 20 to reflect light from the light source 22 toward the glare-eliminating optical system 30.

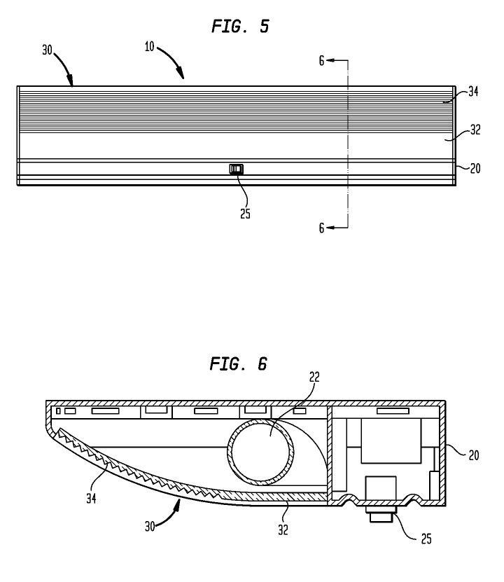

In FIG. 5, the glare-eliminating optical system 30 is shown mounted on the housing 20 of the light fixture 10. The glare-eliminating optical system 30 is preferably made from a transparent optical material (e.g., acrylics, cyclic olefins, polycarbonates, etc.) that functions as a lens for diffusing light emanating from light source 22. The glare-eliminating optical system 30 may possess a multitude of shapes, including (but not limited to) a flat shape or a curved shape, or combination thereof. The glare-eliminating optical system 30 preferably covers and at least partially surrounds the light source 22. The glare-eliminating optical system 30 is preferably releasably mounted on the housing 20 by insertion of the forward and rear edges of the glare-eliminating optical system 30 below respective flanges or portions of the housing 20. The glare-eliminating optical system 30 may be frosted or coated on its inner surface 30b or outer surface 30a.

The glare-eliminating optical system 30 preferably includes a textured area or surface 34 on its outer surface 30b having an array of longitudinally extending prisms or other elements for diffusing and/or redirecting light from the light source 22. The glare-eliminating optical system 30 also preferably includes a substantially smooth or non-textured area 32 at least below the light source 22 that does not redirect light illuminated by the light source. The absence of redirected light passing through the non-textured area 32 eliminates or at least minimizes undesirable direct glare when the light fixture is mounted at or above eye level.

FIG. 6 is a cross-sectional view of the light fixture 10 showing the glare-eliminating optical system 30 mounted on the housing 22. The textured area 34 containing the array of longitudinally extending prisms or other elements is shown in the arcuate or curved portion of the glare-eliminating optical system 30. Similarly, the substantially smooth, non-textured area 32 of the glare-eliminating optical system 30 is shown in the area below the light source 22.

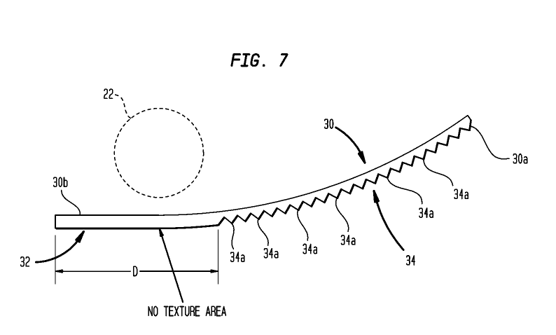

FIG. 7 is a side elevation view of the glare-eliminating optical system 30. The light source 22 is illustrated in ghost lines above the glare-eliminating optical system 30. The glare-eliminating optical system 30 includes an outer surface 30a and an inner surface 30b. As mentioned above, the inner surface 30b or outer surface 30a may be frosted or otherwise coated.

The outer surface 30a of glare-eliminating optical system 30 is preferably divided into two areas-the substantially smooth, non-textured area 32 and the textured area 34. The substantially smooth, non-textured surface 32 is illustrated below the light source 22 and extends a distance D from the end of the glare-eliminating optical system 30 closest to the light source. The distance D is preferably a distance sufficient to permit the non-textured area 32 to extend at least to the edge of the lamp holder in which the light source 22 is mounted. The non-textured area 32 provides a desired light shielding effect, but does not redirect or otherwise scatter light illuminated by the light source 22 that passes through the non-textured area 32.

The textured area 34 is illustrated in FIG. 7 as preferably including an array of longitudinally extending prisms or other elements 34a for diffusing and/or redirecting light from the light source 22. The glare-eliminating optical system 30 may be made via an extrusion process or other known manner to form the array of longitudinally extending prisms or other elements 34a. Each longitudinally extending prism or other element 34a is separated by a channel or trough extending horizontally or longitudinally along the textured area 34 of the glare-eliminating optical system 30. These longitudinally extending prisms 34a and associated channels or troughs redirect light illuminated by the light source 22, as well as minimize shadowing and hot spots.

As an alternative to forming the array of longitudinally extending prisms or other elements 34a on the outer surface 30a of the glare-eliminating optical system 30, the array of longitudinally extending prisms or other elements 34a may be formed on the inner surface 30b of the glare-eliminating optical system 30.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. An undercabinet light fixture, comprising:
a housing for supporting a light source;
a glare-eliminating optical system mounted on the housing and through which light illuminated by the light source passes, the glare-eliminating optical system including a textured surface and a non-textured surface;
the textured surface including an array of longitudinally extending prismatic elements for redirecting light illuminated from the light source; and
the non-textured surface located below the light source and permitting light illuminated from the light source to pass therethrough without being substantially redirected.

2. The undercabinet light fixture of claim 1, wherein the array of longitudinally extending prismatic elements further comprises a plurality of generally v-shaped grooves extending longitudinally along an outer surface of the glare-eliminating optical system.

3. The undercabinet light fixture of claim 1, wherein the non-textured surface located below the light source is substantially flat and the textured surface is curved.

4. The undercabinet light fixture of claim 3, wherein the curvature of the textured surface increases in proximity to the non-textured surface.

5. The undercabinet light fixture of claim 1, wherein the glare-eliminating optical system and housing fully enclose the light source.

6. The undercabinet light fixture of claim 1, wherein at least a portion of an inner surface of the glare-eliminating optical system is frosted.

7. The undercabinet light fixture of claim 1, wherein at least a portion of an outer surface of the glare-eliminating optical system is frosted.

8. The undercabinet light fixture of claim 1, wherein the glare-eliminating optical system is generally concave with respect to the light source.

9. The undercabinet light fixture of claim 1, wherein the glare-eliminating optical system is formed from an acrylic material.

10. The undercabinet light fixture of claim 1, wherein the light source comprises a fluorescent light source.

11. A glare-eliminating optical system for an undercabinet light fixture, comprising:
a textured surface including an array of longitudinally extending prismatic elements for redirecting light illuminated from a light source; and
a non-textured surface located below the light source through which light illuminated from the light source passes without being substantially redirected.

12. The glare-eliminating optical system of claim 11, wherein the array of longitudinally extending prismatic elements comprises a plurality of generally v-shaped grooves extending longitudinally along an outer surface of the glare-eliminating optical system.

13. The glare-eliminating optical system of claim 11, wherein the non-textured surface located below the light source is substantially flat and the textured surface is curved.

14. The glare-eliminating optical system of claim 13, wherein the curvature of the textured surface increases in proximity to the non-textured surface.

15. The undercabinet light fixture of claim 11, wherein the glare-eliminating optical system at least partially surrounds the light source.

16. The glare-eliminating optical system of claim 11, wherein at least a portion of an inner surface of the glare-eliminating optical system is frosted.

17. The glare-eliminating optical system of claim 11, wherein at least a portion of an outer surface of the glare-eliminating optical system is frosted.

18. The glare-eliminating optical system of claim 11, wherein the glare-eliminating optical system is generally concave with respect to the light source.

19. The glare-eliminating optical system of claim 11, wherein the glare-eliminating optical system is formed from an acrylic material.

20. The glare-eliminating optical system of claim 11, wherein the light source comprises a fluorescent light source.
